(19) United States
(12) Patent Application Publication
(10) Pub. No.: US 2011/0230240 A1
(43) Pub. Date: Sep. 22, 2011

(54) Handheld recharging device for use with cell phone

(76) Inventor: Seuk-Hyun Bang, Chungcheongnam-do (KR)

(21) Appl. No.: 12/744,570

(22) PCT Filed: Nov. 27, 2009
(86) PCT No.: PCT/KR2009/006732

§ 371 Date: May 25, 2010

(51) Int. Cl. H04M 1/00

(52) U.S. Cl. 455/573

(57) ABSTRACT

The present invention provides a handheld recharging device for use with a cell phone which makes a user of the cell phone grasp comfortably or naturally with one hand to carry and use it, and discharges efficiently and quickly heat generated from using and recharging the cell phone to external space, and, hence, secures a more stable operation of the cell phone and prohibits a deterioration in efficiency of a recharging battery and deformations of the housings. The device is characterized in that, first thing, only portions between lower portions and most upper portions of both side faces remain, secondly, both side portions of a rear face which faces away a rear face of the cell phone are not contact with the rear face of the cell phone, and, thirdly, both of side lines corresponding to the remaining portions and upper portions of the rear face have convex shapes, whereas both of side lines corresponding to a lower portion of the rear face have concave shapes.

### TECHNICAL FIELD

The present invention relates to a handheld recharging device for use with a cell phone. More particularly, the present invention relates to the handheld recharging device which incorporates a recharging battery therein, and into which the cell phone can be mounted, and which can recharge the cell phone mounted therein with the recharging battery anytime and anywhere.

### BACKGROUND ART

Generally, a cell phone uses a battery as a power supply, whereas a wire-line telephone does not use the battery as the power supply. This is why a battery becomes more important component in the cell phone than in the wire-line telephone.

Recently, as the cell phone becomes more and more small and light, the battery becomes more and more thin. Accordingly, the battery is likely to be exhausted more quickly, and, thus, needs to be recharged more frequently. Such an exhausting becomes more outstanding when various functions such as taking moving-pictures, playing multi-media, connecting with internet or receiving satellite-broadcasting signals, etc are carried out in the cell phone or calling time or calling amount increases. As a result, recharging the cell phone becomes more significant requirement recently.

One way to meet this requirement is to use a separate recharging device which is placed in home or an office to recharge the cell phone with alternating current having 110/220 voltage or is placed in a vehicle to recharge the cell phone with a cigarette socket power supply.

This way, however, is disadvantageous in that it is difficult to recharge the cell phone in particular places where the alternating current is not provided other than in the home or office or in that it is inconvenient to turn on an engine of the vehicle whose engine was off only in order to recharge the cell phone with the cigarette socket power supply.

An alternative way is to carry a sub-battery separate from a main-battery which is incorporated in the cell phone and to replace the main-battery with the sub-battery when the main-battery is exhausted out, resulting in a continuous turning-on state of the cell phone. This way, however, is problematic in that the sub-battery can be often damaged due to carelessness of a user of the cell phone or external impacts in carrying the sub-battery. Further, to carry the sub-battery, per se, is a burden to the user.

To solve such problems, a portable or handheld recharging device has been developed into which the cell phone can be mounted, and which incorporates a recharging battery therein, and can recharge the cell phone in electrical depletion of the cell phone by supplying electrical charges from the recharging battery into the main-battery which is incorporated in the cell phone. With using the portable recharging device, the continuous turning-on state of the cell phone can be accomplished and, hence, interruptions of communications on the cell phone can be inhibited, and, at the same time, the damages to the recharging battery due to the carelessness of the user of the cell phone or the external impacts can be prohibited. Moreover, to carry the recharging device and the cell phone mounted therein together may be not inconvenient to the user.

FIG. 1 shows a prior art portable recharging device which recharges a cell phone to be mounted therein. FIG. 2 to FIG. 4 show front, top, and rear views of the portable recharging device of FIG. 1 and the cell phone mounted therein respectively. FIG. 5 illustrates how the portable recharging device discharges heat generated from the cell phone to external space. FIG. 6 shows a state when a user of the cell phone grasps the recharging device with one hand in order to carry and use it.

To be specific, the prior-art portable recharging device 10 shown in FIG. 1 to FIG. 4 comprises a recharging battery (not shown) embedded therein, a body 11 into which the cell phone 20 is mounted with a rear face of the cell phone 20 facing and being contact with a large receiving rear face of the body 11 of the recharging device 10, and a battery output terminal 12 which is disposed at a bottom face of the body 11 and outputs a power source of the recharging battery to the cell phone 20.

A top face of the body 11 is open or removed so that the cell phone 20 should be inserted from and through it downwardly and be removed through it upwardly. A front face of the body 11, also, is open or removed so that a displaying unit disposed at a front face of the cell phone 20 should be visible.

In the body 11, there are both side faces whose upper portions are partially removed or open, and the bottom face of which all portions remain. Remaining portions of the both side faces and the bottom face of the body 11 cover corresponding portions of both side faces and a bottom face of the cell phone 20 to receive the cell phone 20. Further, the remaining portions of the both side faces and the bottom face of the body 11 bend and extend toward inner directions of the front face of the cell phone 20 so as to cover periphery regions of the front face of the cell phone 20 and fix the cell phone 20 within the recharging device 10.

The battery output terminal 12 is connected to a power supply terminal 21 (refer to FIG. 12) disposed in a bottom portion of the cell phone 20, and outputs the power source of the recharging battery to the cell phone 20.

A battery electrical charge level indicator (for example, such an indicator 150 appears in FIG. 10) may be installed in the body 11 to indicate an electrical charge state of the recharging battery embedded in the recharging device 10.

To mount the cell phone 20 into the recharging device 10, the cell phone 20 is inserted downwardly between the remaining and bending portions of the both side faces of the body 11 as the power supply terminal 21 of the cell phone 20 is placed in a downward direction. Next, the cell phone 20 is pressed downwardly until the power supply terminal 21 thereof can be connected to the battery output terminal 12 of the recharging device 10.

In this way, the cell phone 20 is supplied with the power source of the recharging battery embedded in the body 11, while the remaining and bending portions of the both side faces and the remaining and bending bottom portions of the bottom face of the body 11 cover and surround the cell phone 20 to fix the cell phone 20 within the recharging device 10.

On the other hand, in this case, as shown in FIG. 2, the cell phone 20 is covered and surrounded by the remaining and bending portions of the both side faces and the remaining and bending portions of the bottom face of the body 11, and, hence, the covered and surrounded portions of the cell phone 20 are sealed up so that any air or heat cannot flow through the sealed portions to the external space.

Furthermore, in this case, as shown in FIG. 3, the rear face of the body 11 faces and becomes close tight with the rear face of the cell phone 20.

In this manner, as shown in FIG. 5, an amount of heat generated from using and recharging the cell phone 20 can be not be discharged with large quantity to the external space only through the open or removed top face of the recharging device 10. That is to say, in this case, the heat discharging opening is limited to a small region, and, hence, a good cooling performance can not be accomplished in the recharging device 10 and the cell phone 20 mounted therein, so that the cell phone 20 may not operate securely or stably.

Moreover, in case that a battery of the cell phone is not attached/detached to/from the cell phone but is embedded and buried in the cell phone, heat generated from the buried battery can not be easily discharged to the external space, and, thus, the heat may accumulate at surfaces of housing of the cell phone in the prior-art portable recharging device 10 shown in FIG. 1 to FIG. 4. In this way, the recharging battery of the recharging device 10 deteriorates in its efficiency, and the housings of the recharging device 10 and the cell phone 20 can be deformed. Such deformations become remarkable in lower portions of the housings.

In addition, an entire outer periphery of the recharging device 10 and, thus, that of the body 11 thereof becomes as substantially rectangular as that of the cell phone 20 as shown in FIG. 2 to FIG. 4. As a result, when the user of the cell phone 20 grasps with one hand the body 11 into which the cell phone 20 has been mounted, the user may feel uncomfortable due to a larger thickness of an entire grasped portion of the recharging device 20 and increase of total weight of the device 10 and cell phone 20. Therefore, it is inconvenient for the user to grasp the body 11 with one hand for a long time to carry or use the cell phone 20.

### DISCLOSURE

### Technical Problem

Accordingly, there are needs to provide a handheld recharging device which incorporates a recharging battery therein, and into which a cell phone is mounted, and which can recharge the cell phone mounted therein with the recharging battery, and which a user of the cell phone grasps comfortably or naturally with one hand for a long time to carry and use it, and which discharges efficiently and quickly the heat generated from using and recharging the cell phone to the external space, and, hence, secures a more stable operation of the cell phone and prohibits the deterioration in efficiency of the recharging battery and the deformations of the housings.

### Technical Solution

The technical problem is solved by providing a handheld recharging device for use with a cell phone. This device comprises a body into which the cell phone is mounted; a recharging battery which is embedded in the body; and a battery output terminal which is disposed at a bottom face of the body, and is connected to a power supply terminal disposed at a bottom face of the cell phone mounted into the body, and outputs a power source of the recharging battery to the cell phone. A top face of the body is open or removed so that the cell phone is inserted into the body downwardly. A front face of the body is open or removed so that a front face of the cell phone is visible. Only portions between lower portions and most upper portions of both side faces of the body 110 remain. The remaining portions of both the side faces and the bottom face of the body bend and extend toward inner directions of the front face of the cell phone so as to cover portions of periphery regions of the front face of the cell phone and fix and maintain the cell phone within the body. Both side portions of the rear face of the body which faces away the rear face of the cell phone are not contact with the rear face of the cell phone. When the cell phone is inserted between the remaining portions of the both side faces of the body and is fixed into the body, the rear face of the body which faces away the rear face of the cell phone is not contact with the rear face of the cell phone at a lower region where the power supply terminal of the cell phone is connected and coupled to the battery output terminal. Through empty spaces formed between the rear face of the cell phone and both the side portions of the rear face of the body which are not contact with the rear face of the cell phone and an empty space formed between the rear face of the cell phone and the rear face of the body which is not contact with the rear face of the cell phone at the lower region, heats generated from the cell phone and the body are discharged into external space.

Further, a shape of the rear face of the body is characterized in that both of side lines corresponding to the remaining portions and upper portions of the rear face of the body have convex shapes, whereas both of side lines corresponding to a lower portion of the rear face of the body have concave shapes. Thus, a user of the cell phone grasps comfortably and easily with one hand the body into which the cell phone is mounted. Moreover, side portions of the cell phone in the lower region where heating level is highest are exposed with maximum level to the external space due to the concave shapes of the rear face in the lower region, thereby enhancing the heat discharging.

### Advantageous Effects

According to the portable recharging device of the present invention, when the user of the cell phone uses, for example in a travel or a business trip, the handheld recharging device which incorporates the recharging battery therein, and into which his/her cell phone is mounted, and which can recharge his/her cell phone with the recharging battery anytime, anywhere and continuously, the recharging device discharges efficiently and quickly the heat generated from using and recharging his/her cell phone to the external space, and, hence, secures the more stable operation of his/her cell phone. Moreover, even in case that a battery of his/her cell phone is not attached/detached to/from his/her cell phone but is embedded and buried in his/her cell phone, heat generated from the buried battery can be easily discharged to the external space, and, thus, the recharging battery of the recharging device can not deteriorate in its efficiency, and housings of the recharging device and the cell phone can not be deformed. Such advantages incur in that only portions between the most upper portions and the lower portions of both side faces of the body remain, and the empty spaces are formed between the rear face of the cell phone and both the side portions of the rear face of the body, and between the rear face of the cell phone and the rear face of the body in the lower region. In other words, the cell phone is mounted and fixed into the recharging device with minimum contact degree between them, and, thus, the internal empty spaces formed between them through which the heats generated from using and recharging the cell phone can be formed with maximum volume degree.

Further, according to the portable recharging device of the present invention, because the shape of the rear face of the body is characterized in that both of side lines corresponding to the remaining portions and the upper portions of the rear face of the body have convex shapes, whereas both of side lines corresponding to a lower portion of the rear face of the body have concave shapes, resulting in a less small thickness of an entire grasped portion of the recharging device and decrease of total weight of the device and cell phone, a user of the cell phone grasps and carries comfortably and easily with one hand for a long time the recharging device into which the cell phone is mounted. Moreover, because side portions of the cell phone in the lower region where heating level is highest are exposed with maximum level to the external space due to the concave shapes of the rear face in the lower region, such exposed regions serve as heat exhausting channels for enhancing the heat exhausting degree to secure more stable operations of the cell phone.

### DESCRIPTION OF DRAWINGS

FIG. 1 shows a prior art portable recharging device which recharges a cell phone to be mounted therein;

FIG. 2 to FIG. 4 show front, top, and rear views of the portable recharging device of FIG. 1 and the cell phone mounted therein respectively;

FIG. 5 illustrates how the portable recharging device of FIG. 2 discharges heat generated from the cell phone to an external space;

FIG. 6 shows a state when a user of the cell phone grasps the recharging device of FIG. 2 with one hand in order to carry and use it;

FIG. 7 shows a portable recharging device according to an embodiment of the present invention;

FIG. 8 to FIG. 10 show front, top, and rear views of the portable recharging device of FIG. 7 and the cell phone mounted therein respectively;

FIG. 11 shows a cross-sectional view taken at an A-A line of the recharging device of FIG. 8;

FIG. 12 illustrates how the portable recharging device of FIG. 8 discharges the heat generated from the cell phone to the external space; and

FIG. 13 shows a state when the user of the cell phone grasps the recharging device of FIG. 8 with one hand in order to carry and use it.

### LIST OF MAIN COMPONENTS IN FIGURES

10: a prior-art portable recharging device

11: a body

12,120: a battery output terminal

20: a cell phone

100: a portable recharging device according to an embodiment of the present invention

110: a body

130: side units for maintaining and fixing a cell phone

140: heat discharging channels

150: a battery electrical charge level indicator

### BEST MODE

A preferable embodiment of the present invention will be described in detail below with reference to the accompanying drawings. This embodiment, however, does not limit the true spirit and scope of the present invention. Rather, this embodiment provides a thorough understanding of the present invention so that one skilled in the relevant art can embody easily the present invention. Accordingly, it is to be understood that such an embodiment is merely illustrative of and not restrictive. It is noted that components which have the same configurations have the same reference numbers and names between the prior art and present invention in the drawings.

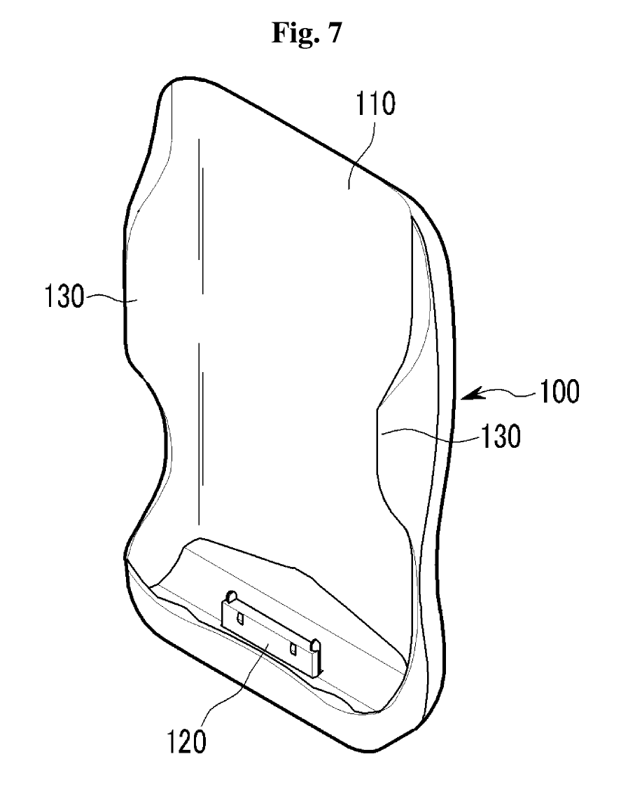

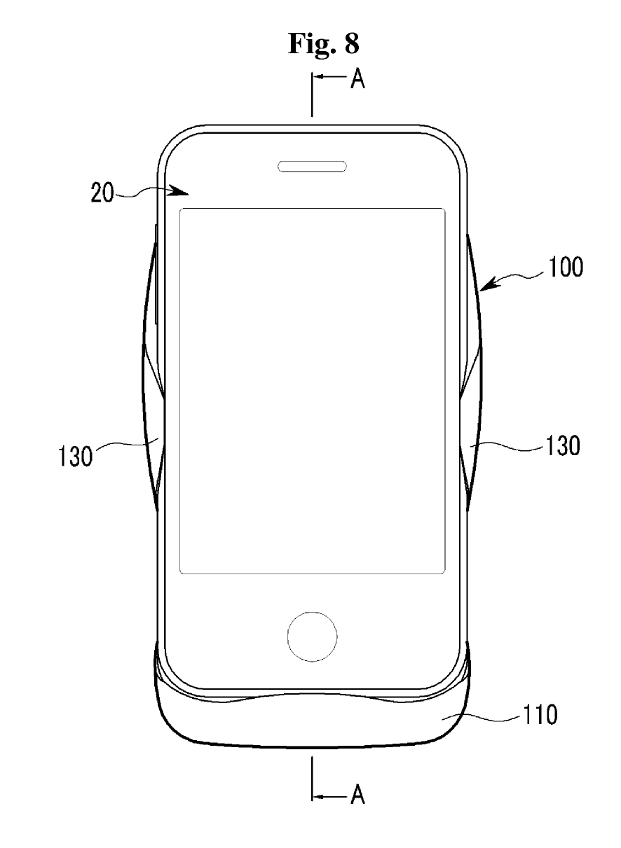

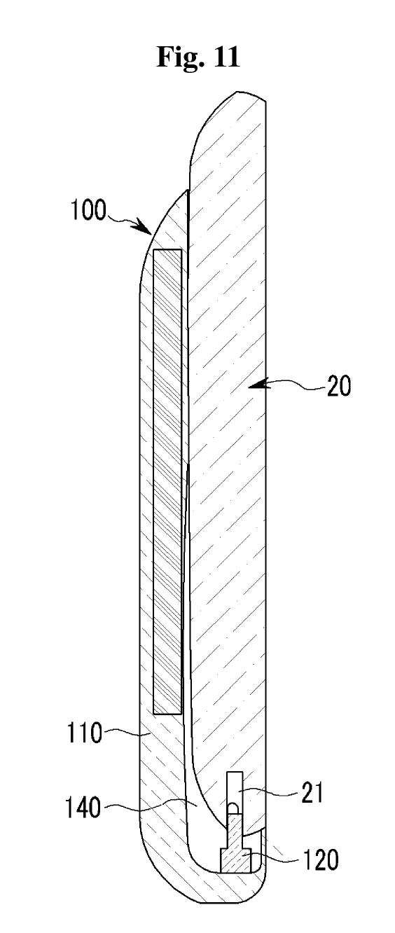

FIG. 7 shows a portable recharging device 100 according to an embodiment of the present invention. FIG. 8 to FIG. 10 show front, top, and rear views of the portable recharging device 100 of FIG. 7 and the cell phone 20 mounted therein respectively. FIG. 11 shows a cross-sectional view taken at an A-A line of the recharging device 100 of FIG. 8.

The portable recharging device 100 according to an embodiment of the present invention has the same configuration as the prior-art portable recharging device 10 in that the recharging battery (not shown) is incorporated in a body 110 of the recharge device 100, the rear face of the cell phone 20 faces and is contact with a rear face of the recharging device 100 so that the cell phone 20 might be mounted into the body 110 of the recharging device 100, a battery output terminal 120 is disposed at a bottom face of the body 100 and outputs a power source of the recharging battery to the cell phone 20, a top face of the body 110 is open or removed so that the cell phone 20 should be inserted from and through it downwardly and be removed through it upwardly, and a front face of the body 110, also, is open or removed so that a displaying unit disposed at the front face of the cell phone 20 should be visible.

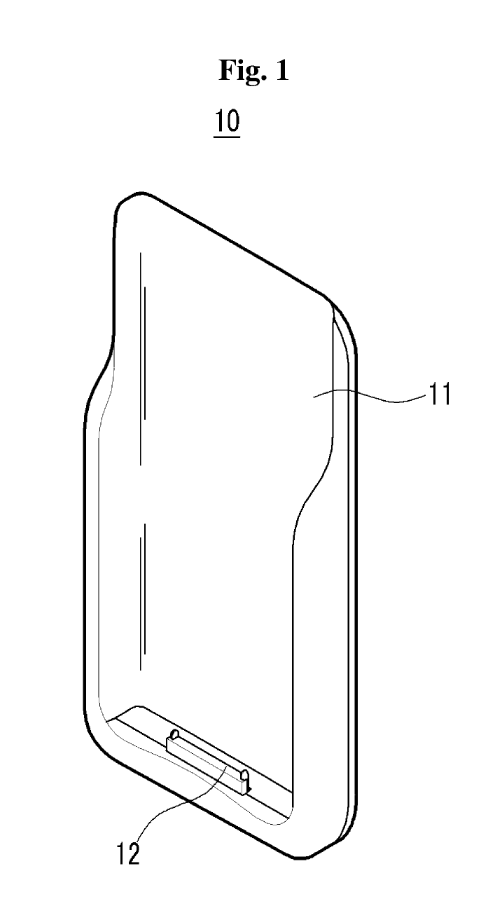

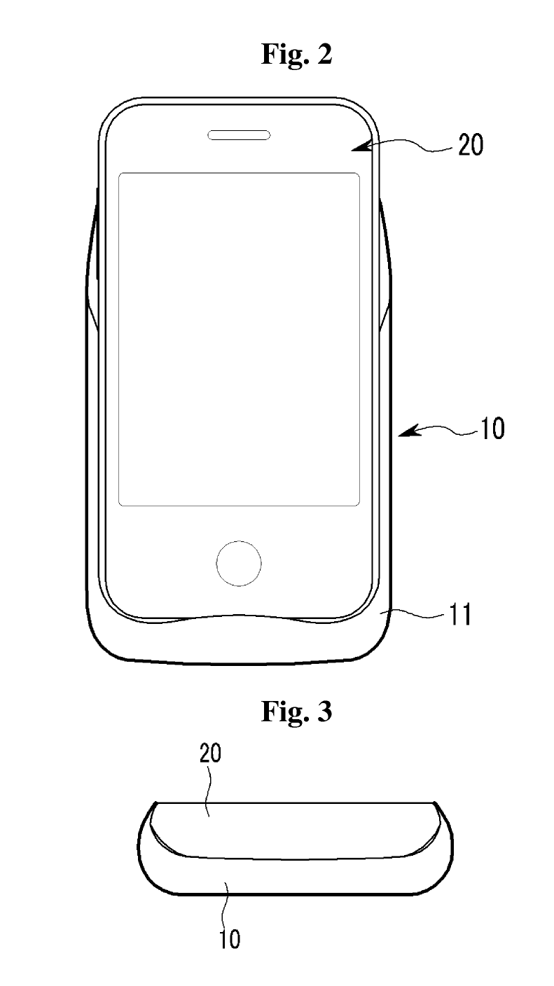

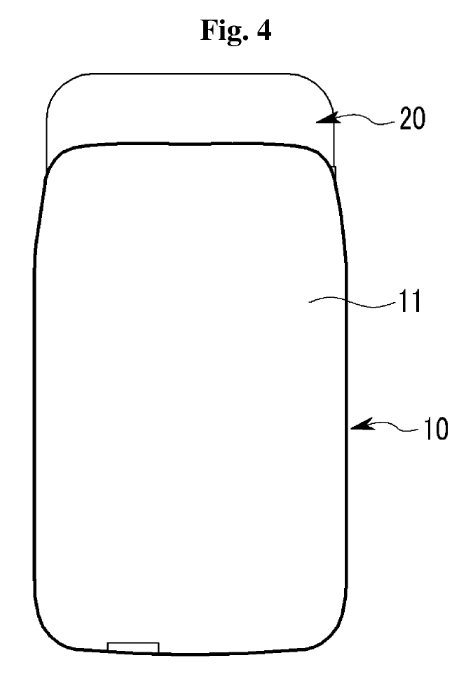

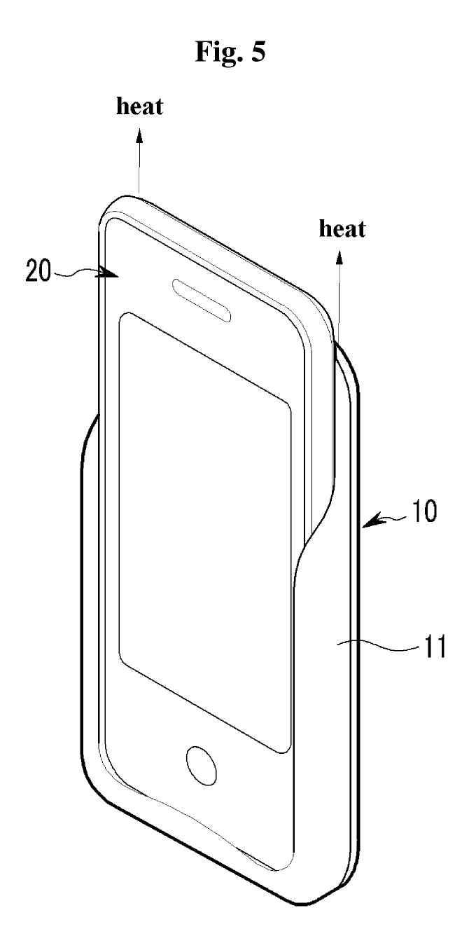

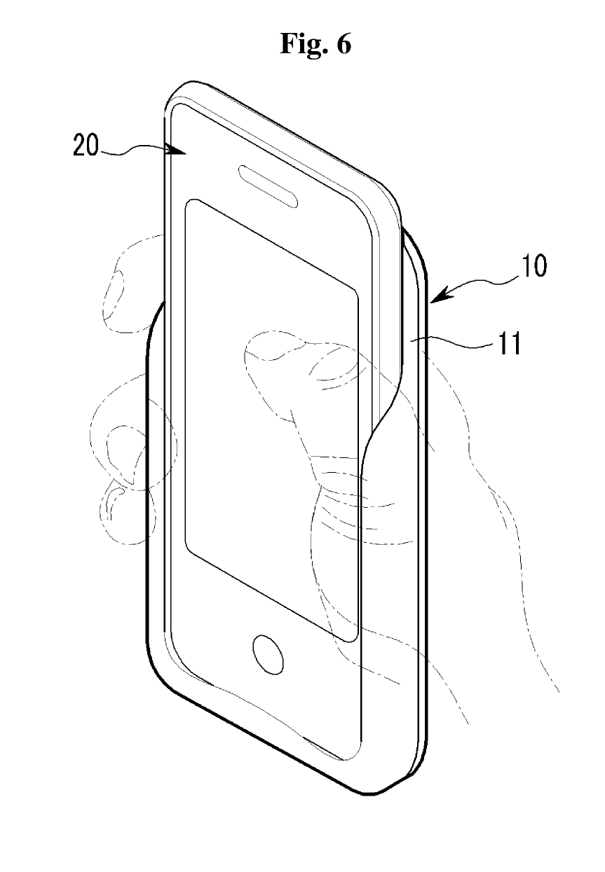

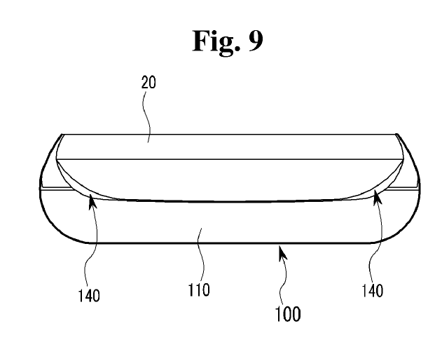

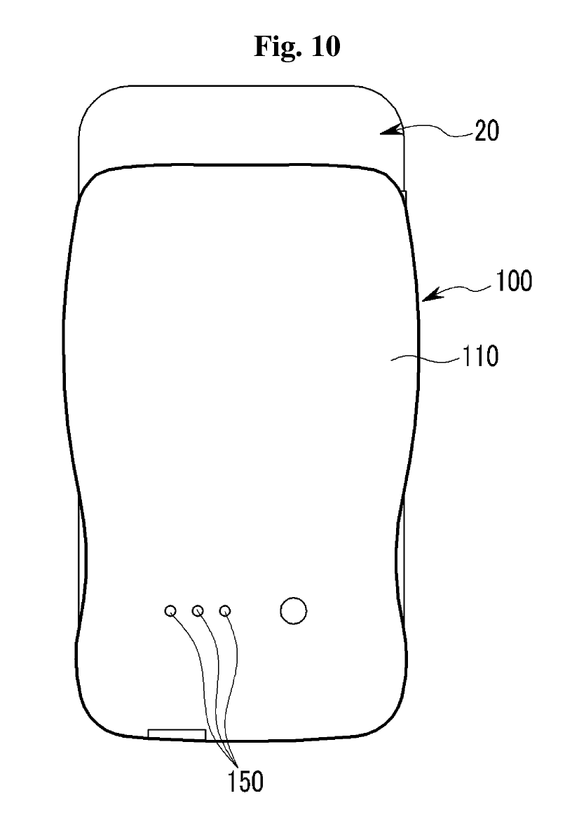

However, the portable recharging device 100 according to an embodiment of the present invention is different from the prior-art portable recharging device 10 as follows. First thing, side units 130 for maintaining and fixing the cell phone 20 are different from those of the recharging device 10. In the recharging device 100, as shown in FIG. 7, only portions between the most upper portions and the lower portions of side faces of the body 110 remain to form the maintaining and fixing units 130. Meanwhile, in the prior-art recharging device 10, as shown in FIG. 1, only the most upper portions of the side faces of the body 11 are removed. Secondly, both side portions of the rear face of the body 110 which faces away the rear face of the cell phone 20 are not contact with the rear face of the cell phone 20 as shown in FIG. 9. Thirdly, a shape of the rear face of the body 110 of the recharging device 100 is different from that of the recharging device 10. So to speak, regarding a shape of the rear face of the body 110 of the recharging device 100, as shown in FIG. 10, both of side lines corresponding to the remaining portions at which the maintaining and fixing units 130 are formed and the upper portions have convex shapes, whereas both of side lines corresponding to the lower portions have concave shapes. Meanwhile, regarding the shape of the rear face of the prior-art recharging device 10, as shown in FIG. 4, both of the entire side lines corresponding to the upper, middle, and lower portions have straight line shapes. In the following, the components which have the same configurations between the present invention and prior art will be not described in detail or be mentioned in brief, while the above-mentioned differences will be mainly focused in the following descriptions.

The body 110 may be made of polycarbonate, etc which can block electromagnetic waves. The recharging battery embedded therein may comprise a nickel-cadmium (Ni—Cd) battery, a nickel-hydrogen (Ni—Mh) battery, a lithium-ion battery, a lithium-polymer battery, etc. In this example, the recharging device 100 may incorporate the lithium-polymer battery which is flexible and thin.

As shown in FIG. 7 to FIG. 10, the body 110 has an elongate hexahedron shape so that the cell phone 20 should be surrounded by and mounted into the body. The top face of the body 110 is open or removed so that the cell phone 20 should be inserted from and through it downwardly and be removed through it upwardly, and the front face of the body 110, also, is open or removed so that the displaying unit disposed at the front face of the cell phone 20 should be visible. The bottom and rear faces of the body 110 are not removed but remain so as to support the cell phone 20. Only the portions between the most upper portions and the lower portions of the side faces of the body 110 remain to form the side units 130 for maintaining and fixing the cell phone 20.

The side units 130 for maintaining and fixing the cell phone 20 may be made of synthetic resin such as the polycarbonate which has elasticity, so that the cell phone 20 can be inserted and fixed more smoothly. Further, because the side units 130 are formed at only small portions, namely, the remaining portions of the side faces, coated surfaces thereof are less peeled due to mutual conflicts between the cell phone 20 and recharging device 100 in inserting/removing the cell phone 20 into/from the recharging device 100.

In the recharging device 100, as shown in FIG. 7, only the remaining portions between the most upper portions and the lower portions of side faces of the body 110 remain to form the maintaining and fixing units 130. Meanwhile, in the prior-art recharging device 10, as shown in FIG. 1, only the most upper portions of the side faces of the body 11 are removed. Accordingly, at a lower region where heating level is highest, both side faces of the body 110 of the recharging device 100 are open or removed, whereas both side faces of the body 11 of the prior art device 10 are not open but closed. Hence, heat generated from the cell phone 20 is discharged through both side openings in not only the most upper regions but also the lower regions in the present invention, whereas the heat is discharged through both side openings only in the most upper region in the prior art. In brief, heat discharging performance is better in the present invention than in the prior art.

The cell phone 20 is inserted downwardly between the remaining portions 130 of the side faces of the body 110 as the power supply terminal 21 of the cell phone 20 is placed in a downward direction. Next, the power supply terminal 21 of the cell phone 20 is connected and coupled to the battery output terminal 120 disposed at the bottom face within the body 110, and, in this way, the cell phone 20 is mounted and fixed into the recharging device 100.

When the cell phone 20 has been inserted between the remaining portions of 130 the both side faces of the body 110 and has been fixed into the body 110, the rear face of the body 110 which faces away the rear face of the cell phone 20, as shown in FIG. 11, is not contact with the rear face of the cell phone 20 at the lower region where the power supply terminal 21 of the cell phone 20 is connected and coupled to the battery output terminal 120. In this manner, through an empty space formed between the rear face of the cell phone 20 and the rear face of the body 110 which is not contact with the rear face of the cell phone 20 at the lower region, the heat generated from the cell phone 20 and the body 110 is discharged into the external space.

The remaining portions 130 of both the side faces and the bottom face of the body 110 bend and extend toward inner directions of the front face of the cell phone 20 so as to cover portions of periphery regions of the front face of the cell phone 20, and fix and maintain the cell phone 20 within the body 110.

Furthermore, as shown in FIG. 9, both side portions of the rear face of the body 110 which faces away the rear face of the cell phone 20 are not contact with the rear face of the cell phone 20. Thus, through empty spaces 140 (i.e. heat discharging spaces) formed between the rear face of the cell phone 20 and both the side portions of the rear face of the body 110 which are not contact with the rear face of the cell phone 20, the heats generated from the cell phone 20 and the body 110 are discharged into the external space. Meanwhile, as shown in FIG. 11, the cell phone 20 can be fixed and maintained within the body 110 as long as the upper portion of the rear face of the cell phone 20 faces and is contact with the corresponding upper portion of the rear face of the body 110.

As shown in FIG. 10, a shape of the rear face of the body 110 is characterized in that both of side lines corresponding to the remaining portions and the upper portions of the rear face of the body 110 have convex shapes, whereas both of side lines corresponding to a lower portion of the rear face of the body 110 have concave shapes.

Such a shape in the rear face of the body 110 results in a less small thickness of an entire grasped portion of the recharging device and decrease of total weight of the device and cell phone. Hence, the user of the cell phone grasps and carries comfortably and easily with one hand for a long time the device into which the cell phone is mounted.

Moreover, in such a shape of the rear face of the body 110, side portions of the cell phone in the lower region where heating level is highest are exposed with maximum level to the external space due to the concave shapes of the rear face in the lower region. Thus, such exposed regions serve as heat exhausting channels for enhancing the heat exhausting degree to secure more stable operations of the cell phone.

On the other hand, in a rear face of the body 110 which dose not face the rear face of the cell phone 20 but faces the external space, as shown in FIG. 10, a battery electrical charge level indicator 150 may be installed to indicate an electrical charge state of the recharging battery embedded in the recharging device 100. Also, this indicator 150 may associate with operations of a switch for supplying the power source to the cell phone, and, accordingly, inform the user of the cell phone whether a recharging operation turns on or off. To this end, a multi-colored LED whose colors change according to the turning-on or turning-off of the recharging may be employed. A power supply receiving terminal for receiving the power source from the external may be disposed at a bottom region of the rear face which dose not face the rear face of the cell phone 20 but faces the external space.

The battery output terminal 120 is disposed at the bottom face of the body 110, and is connected to the power supply terminal 21 disposed at a bottom face of the cell phone 20 mounted into the body, and outputs the power source of the recharging battery to the cell phone 20.

Now, a process of using the handheld recharging device 100 according to an embodiment of the present invention will be explained in detail below with reference to accompanying drawings.

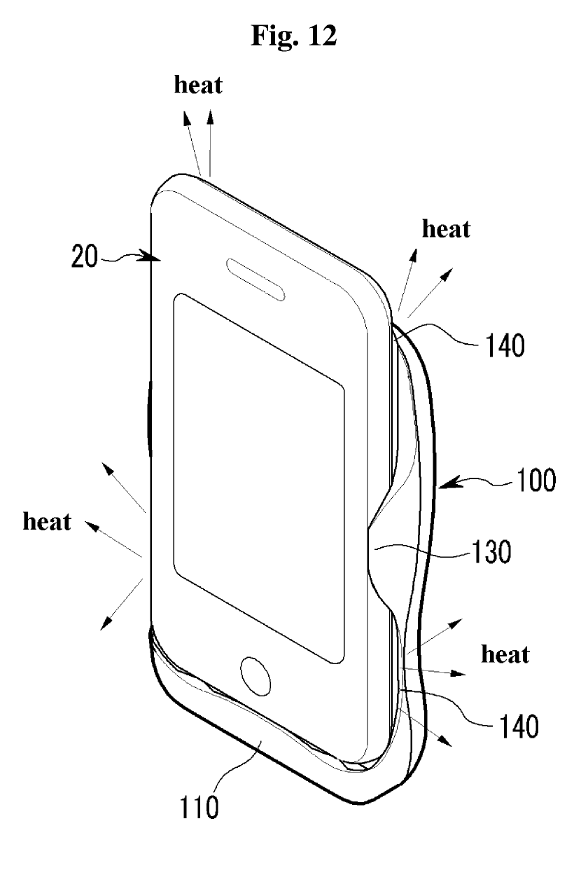

FIG. 12 illustrates how the portable recharging device of FIG. 8 discharges to the external space the heat generated from the cell phone mounted therein.

As the cell phone 20 has been mounted into the handheld recharging device 100 according to an embodiment of the present invention, the cell phone 20 is contact with the maintaining and fixing side units 130 formed between the most upper portions and the lower portions of side faces of the body 110, the battery output terminal 120 which is disposed on the bottom face of the body 110, and an upper surface of the bottom face of the body. At the same time, the remaining portions 130 of both the side faces and the bottom face which bend and extend toward the inner directions of the front face of the cell phone 20 surround and cover portions of the cell phone, and fix and maintain the cell phone 20 within the body.

In the lower region where the power supply terminal 21 of the cell phone is connected and coupled to the battery output terminal 120 of the body 110, through the empty space 140 formed between the rear face of the cell phone 20 and the rear face of the body 110 which faces away the rear face of the cell phone 20 and is not contact with the rear face of the cell phone 20, the heats generated from the cell phone 20 and the body 110 are discharged in left and right directions to the external space. At the same time, through the empty spaces 140 formed between the rear face of the cell phone 20 and both side portions of the rear face of the body 110 which faces away the rear face of the cell phone 20 and are not contact with the rear face of the cell phone, the heats generated from the cell phone 20 and the body 110 are discharged upwardly and downwardly to the external space.

As an alternative way, protrusions may be formed on the rear face of the body 110 which faces the rear face of cell phone or the entire rear face of the body 110 may have a convex shape, so that through the resulting empty spaces the heats can be discharged to the external space.

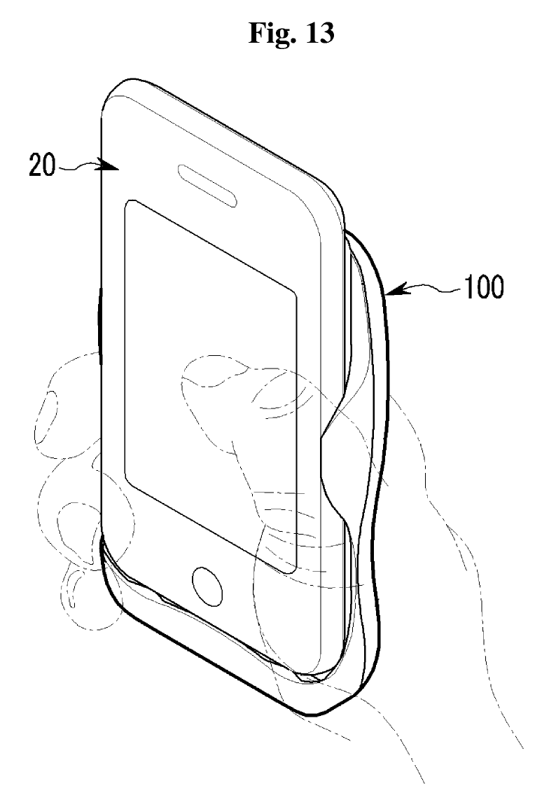

FIG. 13 shows a state when the user of the cell phone 20 grasps the recharging device 100 of FIG. 8 with one hand in order to carry and use it.

As mentioned above, regarding the shape of the rear face of the body 110, both of side lines corresponding to the remaining portions 130 and the upper portions of the rear face of the body 110 have convex shapes, whereas both of side lines corresponding to the lower portion of the rear face of the body 110 have concave shapes. This shape results in the less small thickness of the entire grasped portion of the recharging device 100 and the decrease of total weight of the device 100 and cell phone 20, and, hence, the user of the cell phone 20 can grasp and carry comfortably and easily with one hand for a long time the device 100 and cell phone 20 mounted therein regardless of a shape of the cell phone 20. In this way, the user of the cell phone 20 can carry and call with the cell phone 20 very conveniently. Because side portions of the cell phone 20 in the lower region where heating level is highest are exposed with maximum level to the external space due to the concave shapes of the rear face in the lower portion, heat exhausting channels for enhancing the heat exhausting degree can be obtained.

The handheld recharging device 100 according to an embodiment of the present invention is advantageous in that the heating exhausting channels are obtained, in particular, in the lower region where the heating level is highest in using the cell phone 20 and, at the same time, the user of the cell phone 20 can grasp and carry comfortably and easily with one hand the recharging device 100. That is to say, the present invention provides a more stable operation of the cell phone due to the good heat exhausting performance and, at the same time, the convenience in carrying and using the cell phone.

The present invention has now been described with reference to exemplifying an implementation or embodiment. However, the invention is not limited to the implementation or embodiment described herein. On the contrary, the full extent of the invention is only determined by the scope of the appended claims.

### INDUSTRIAL APPLICABILITY

The handheld recharging device according to the present invention incorporates the recharging battery, and, thus, can recharge the cell phone mounted therein anytime, anywhere and continuously, and makes the user of the cell phone grasp comfortably or naturally the cell phone, and discharges in not only a upper direction but also left and right directions efficiently with large quantity the heats generated from using and recharging the cell phone, and hence, secures the more stable operation of the cell phone and prohibits the deterioration in efficiency of the recharging battery and the deformations of the housings.

1. A handheld recharging device for use with a cell phone, comprising:
a body into which the cell phone is mounted;
a recharging battery which is embedded in the body; and
a battery output terminal which is disposed at a bottom face of the body, and is connected to a power supply terminal disposed at a bottom face of the cell phone mounted into the body, and outputs a power source of the recharging battery to the cell phone,
wherein a top face of the body is open or removed so that the cell phone is inserted into the body downwardly,
a front face of the body is open or removed so that a front face of the cell phone is visible,
only portions between lower portions and most upper portions of both side faces of the body remain,
the remaining portions of both the side faces and the bottom face of the body bend and extend toward inner directions of the front face of the cell phone so as to cover portions of periphery regions of the front face of the cell phone and fix and maintain the cell phone within the body,
both side portions of the rear face of the body which faces away the rear face of the cell phone are not contact with the rear face of the cell phone,
when the cell phone is inserted between the remaining portions of the both side faces of the body and is fixed into the body, the rear face of the body which faces away the rear face of the cell phone is not contact with the rear face of the cell phone at a lower region where the power supply terminal of the cell phone is connected and coupled to the battery output terminal, and
through empty spaces formed between the rear face of the cell phone and both the side portions of the rear face of the body which are not contact with the rear face of the cell phone and an empty space formed between the rear face of the cell phone and the rear face of the body which is not contact with the rear face of the cell phone at the lower region, heats generated from the cell phone and the body are discharged into an external space.

2. The handheld recharging device of claim 1, wherein a shape of the rear face of the body is characterized in that both of side lines corresponding to the remaining portions and the upper portions of the rear face of the body have convex shapes, whereas both of side lines corresponding to a lower portion of the rear face of the body have concave shapes, so that a user of the cell phone grasps comfortably and easily with one hand the body into which the cell phone is mounted, and side portions of the cell phone in the lower region where heating level is highest are exposed with a maximum level to the external space due to the concave shapes of the rear face in the lower region, thereby enhancing the heat discharging.
